(19) United States
(12) Patent Application Publication
(10) Pub. No.: US 2012/0254215 A1
(43) Pub. Date: Oct. 4, 2012

(54) DISTRIBUTED FILE SYSTEM, DATA SELECTION METHOD THEREOF, AND PROGRAM

(76) Inventor: Michitaro Miyata, Tokyo (JP)

(21) Appl. No.: 13/514,431

(22) PCT Filed: Dec. 9, 2010
(86) PCT No.: PCT/JP2010/072107

§ 371 Date: Jun. 7, 2012

(30) Foreign Application Priority Data
Dec. 10, 2009 (JP) 2009-280661

(51) Int. Cl. G06F 17/30

(52) U.S. Cl. 707/758; 707/E17.014

(57) ABSTRACT

A distributed file system includes: a storage system including a plurality of storage units distributing and storing data corresponding to metadata, each of the storage units being in one of a plurality of operating states; a data acquisition unit acquiring data corresponding to a search request including desired metadata; and a management unit managing which of the storage units stores data corresponding to the metadata, managing an operating state of each of the storage units, and supplying a search result based on management contents responsive to a search request from the data acquisition unit. Based on search result, data acquisition unit accesses storage unit(s) in an active state more preferentially than storage unit(s) in an inactive state to acquire desired data.

### TECHNICAL FIELD

### Reference to Related Application

The present invention is based upon and claims the benefit of the priority of Japanese patent application No. 2009-280661, filed on Dec. 10, 2009, the disclosure of which is incorporated herein in its entirety by reference thereto. The present invention relates to a distributed file system, a data selection method thereof, and a program. In particular, it relates to a power-saving technique achieved by the system, the method, or the program.

### BACKGROUND ART

Conventionally, a technique of distributing and storing data in a plurality of storage nodes is known. Such technique is referred to as distributed storage, a distributed file system, a parallel file system, and the like. According to this technique, not only files are simply distributed and stored in a plurality of storage nodes but also files are divided into more detailed units and stored in a plurality of storage nodes or duplicated files are stored in a plurality of storage nodes. In this way, the throughput performance can be improved and the possibility of data loss can be reduced (see Non-Patent Document 1, for example). Non-Patent Document 1 discloses a system in which many PC clusters are distributed and data can be accessed by executing a search using metadata.

The metadata represents attribute information about data, such as a creator and a creation date of data. In a distributed file system in which file groups distributed and stored are managed by a single file system, metadata represents file paths, file names, or the like. In a system in which a file is divided into smaller units and the units are distributed and stored, metadata represents location information in a file. In the case of image files captured with a digital camera as contents, metadata represents information about photographers, subjects, and locations.

For power-saving purposes, there is known a technique of stopping the rotation of a hard disk drive in which data is stored or turning off the power supply of the hard disk drive (see Patent Document 1, for example). Such power-saving technique is applicable to the above system in which data is distributed and stored in a plurality of storage nodes. For example, if a storage node has not been accessed for a certain period of time, by stopping the rotation of a hard disk drive of the storage node, the power consumption can be reduced.

### RELATED DOCUMENT(S)

### Patent Document

Patent Document 1: Japanese Patent No. 4325817

### Non-patent Document

Non-Patent Document 1: Osamu Tatebe, Youhei Morita, Satoshi Matsuoka, Satoshi Sekiguchi, and Noriyuki Soda, “Grid Datafarm Architecture for Petascale Data Intensive Computing,” IPSJ SIG Technical Reports, 2001-HPC-87, SWoPP2001, pp.177-182, July 2001.

### SUMMARY OF THE INVENTION

### Problems to be Solved by the Invention

The entire disclosures of the above Patent Document 1 and Non-Patent Document 1 are incorporated herein by reference thereto. The following analyses are given by the present invention.

When data is accessed by executing a search using metadata as described in Non-Patent Document 1, there are cases where all the data does not need to be accessed. For example, if a metadata search result indicates a plurality of duplicated data stored in different storages, accessing one of the data can provide desired data. However, no technique of suppressing an increase of power consumption in such case is disclosed for such a conventional search system using metadata. Thus, the power consumption of the system cannot be decreased.

Therefore, an object of the present invention is to provide a distributed file system (apparatus), a data selection method thereof, and a program that realize lower power consumption.

### Means to Solve the Problems

A distributed file system (apparatus) according to an aspect of the present invention comprises: a storage system including a plurality of storage units that distribute and store data corresponding to metadata, each of the storage units being in one of a plurality of operating states; a data acquisition unit that acquires data corresponding to a search request including desired metadata; and a management unit that manages which of the storage units stores data corresponding to the metadata, manages an operating state of each of the storage units, and supplying a search result based on management contents in response to a search request from the data acquisition unit. Based on the search result, the data acquisition unit accesses the storage unit(s) in an active state more preferentially than the storage unit(s) in an inactive state to acquire desired data.

A data selection method according to another aspect of the present invention is used in a distributed file system comprising a storage system including: a plurality of storage units that distribute and store data corresponding to metadata, each of the storage units being in one of a plurality of operating states; a server; and a client(s). The data selection method comprises steps of: causing the client to transmit a search request including desired metadata to the server; causing the server to transmit information about the storage unit(s) storing data corresponding to the metadata and information about operating states of the storage unit(s) to the client as a reply; and causing the client, based on the reply from the server, to access the storage unit(s) in an active state more preferentially than the storage unit(s) in an inactive state to acquire desired data.

A program according to another aspect of the present invention causes a computer, which forms a distributed file system comprising a storage system including: a plurality of storage units that distribute and store data corresponding to metadata, each of the storage units being in one of a plurality of operating states; a server; and a client(s), to execute processes of: causing the client to transmit a search request including desired metadata to the server; causing the server to transmit information about the storage unit(s) storing data corresponding to the metadata and information about operating states of the storage unit(s) to the client as a reply; and causing the client, based on the reply from the server, to access the storage unit(s) in an active state more preferentially than the storage unit(s) in an inactive state to acquire desired data.

### Meritorious Effects of the Invention

According to the present invention, access to the storage units in an inactive state is controlled, and an increase of power consumption relating to the activation is suppressed. Thus, lower power consumption can be realized.

### BRIEF DESCRIPTION OF THE DRAWINGS

FIG. 1 illustrates a configuration of a distributed file system according to a first exemplary embodiment of the present invention.

FIG. 2 illustrates a configuration of a client according to the first exemplary embodiment of the present invention.

FIG. 3 illustrates a configuration of a metadata server according to the first exemplary embodiment of the present invention.

FIG. 4 illustrates a configuration of a storage node according to the first exemplary embodiment of the present invention.

FIG. 5 illustrates a configuration of a metadata storage unit according to the first exemplary embodiment of the present invention.

FIG. 6 illustrates a configuration of an arrangement information storage unit according to the first exemplary embodiment of the present invention.

FIG. 7 illustrates a configuration of an operating state information storage unit according to the first exemplary embodiment of the present invention.

FIG. 8 is a flow chart illustrating an operation of the client according to the first exemplary embodiment of the present invention.

FIG. 9 is a flow chart illustrating an operation of the metadata server according to the first exemplary embodiment of the present invention.

FIG. 10 is a flow chart illustrating an operation of the storage node according to the first exemplary embodiment of the present invention.

FIG. 11 illustrates a configuration of a distributed file system according to a first example of the present invention.

FIG. 12 illustrates a configuration of a metadata storage unit according to the first example of the present invention.

FIG. 13 illustrates a configuration of an arrangement information storage unit according to the first example of the present invention.

FIG. 14 illustrates a configuration of an operating state information storage unit according to the first example of the present invention.

FIG. 15 is a sequence diagram illustrating an operation of the distributed file system according to the first example of the present invention.

FIG. 16 is a flow chart illustrating an operation of a client according to a second exemplary embodiment of the present invention.

FIG. 17 is a flow chart illustrating an operation of a metadata server according to the second exemplary embodiment of the present invention.

### MODES FOR CARRYING OUT THE INVENTION

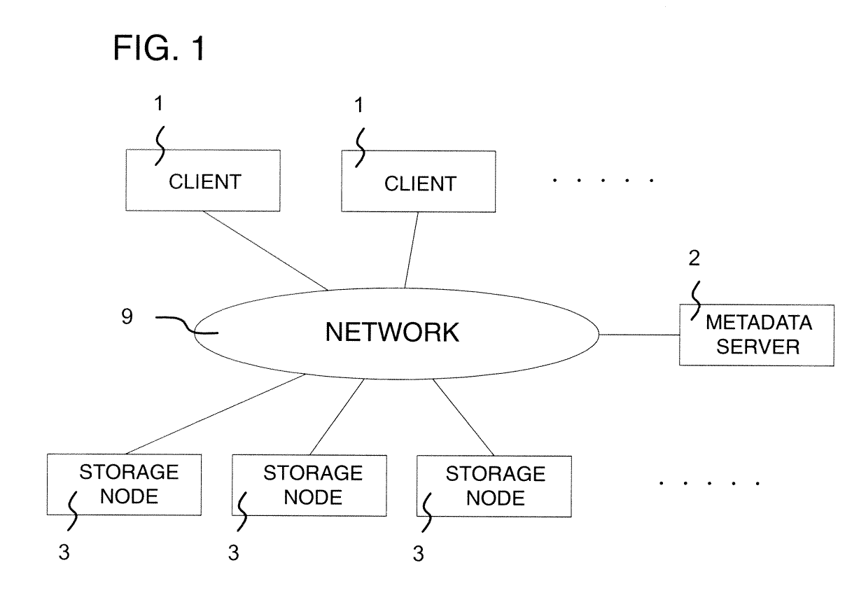

A distributed file system according to an exemplary embodiment of the present invention comprises: a storage system (corresponding to a group of storage nodes 3 in FIG. 1) including a plurality of storage units (corresponding to the storage nodes 3 in FIG. 1) that distribute and store data corresponding to metadata, each of the storage units being in one of a plurality of operating states; a data acquisition unit (corresponding to a client 1 in FIG. 1) that acquires data corresponding to a search request including desired metadata; and a management unit (corresponding to a metadata server 2 in FIG. 1) that manages which of the storage units stores data corresponding to the metadata, manages an operating state of each of the storage units, and supplies a search result based on management contents in response to a search request from the data acquisition unit. Based on the search result, the data acquisition unit accesses the storage unit(s) in an active state more preferentially than the storage unit(s) in an inactive state to acquire desired data.

According to the distributed file system, the search result may include information about the storage unit(s) storing data corresponding to the desired metadata and information about operating states of the storage unit(s), and based on the search result, the data acquisition unit may access the storage unit(s) to acquire the desired data.

According to the distributed file system, the search request may further include selection criteria information, and the search result may include information about the storage unit(s) storing data that matches the selection criteria information and that corresponds to the desired metadata and information about operating states of the storage unit(s).

According to the distributed file system, it is preferable that the storage unit(s) in an active state has larger power consumption than the storage unit(s) in an inactive state.

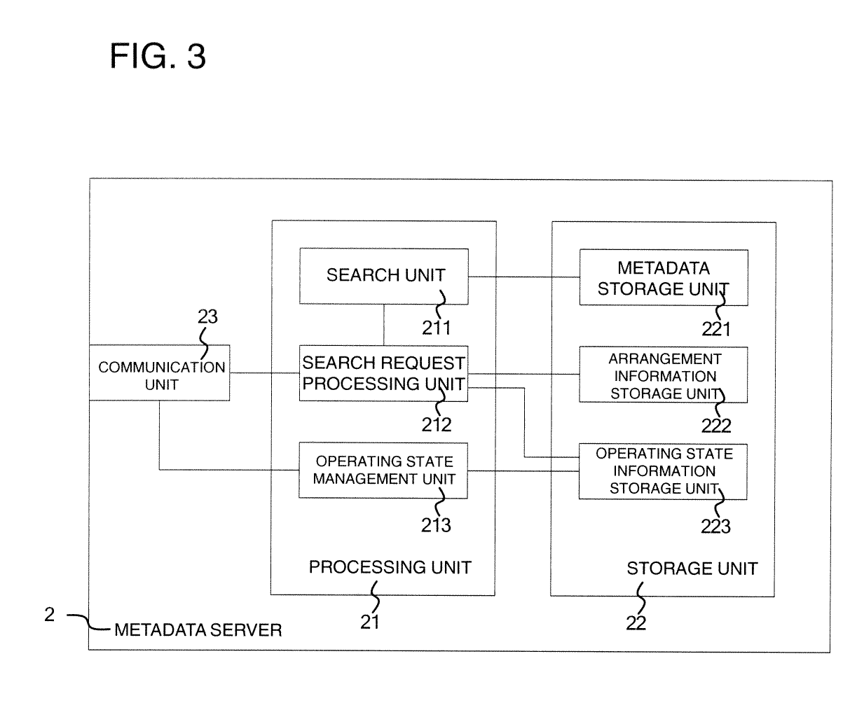

According to the distributed file system, the management unit may include a management storage unit (corresponding to 22 in FIG. 3) that stores object identifiers corresponding to the metadata, storage unit identifiers corresponding to the object identifiers, and storage unit operating states corresponding to the storage unit identifiers, and the management unit may execute a management by referring to the management storage unit.

According to the distributed file system, the management unit may receive operating states of the storage unit(s) from the storage unit(s) and update information in the management storage unit.

According to the distributed file system, the storage unit in an active state may be brought in an inactive state if the storage unit satisfy a stop condition.

According to the distributed file system, the metadata may include a combination of an attribute and a value.

According to the distributed file system, the management unit and the data acquisition unit may be a server and a client(s), respectively, and the storage system, the server, and the client(s) may be connected via a network.

In addition, from another point of view, the distributed file system according to an exemplary embodiment of the present invention comprises: a metadata search means selecting a candidate data group corresponding to given metadata conditions from a data group; and an operating state supply means associating each data of the selected candidate data group with an operating state of a device storing the each data. In addition, the distributed file system comprises an access data selection means using an operating state as a determination means, to determine the order of priority of the data group to be accessed among the candidate data group.

Generally, accessing a storage node in a power-saving mode requires more time than accessing a storage node that is not in a power-saving mode. For example, to access data in a hard disk whose rotation is stopped for power saving, a disk rotation process needs to be executed. Thus, accessing the data requires more time than accessing data in a rotating hard disk.

According to the distributed file system of the present exemplary embodiment, by reducing the number of accesses to data in the storage units in a power-saving state, an increase of power consumption relating to the activation is suppressed. In addition, since the number of accesses to the storage units in a power-saving state is reduced, the number of waiting operations required for activation from a power-saving state can be suppressed and reduced.

Hereinafter, a distributed file system will be described in more detail with reference to the drawings.

### FIRST EXEMPLARY EMBODIMENT

FIG. 1 is a block diagram illustrating a configuration of a distributed file system according to a first exemplary embodiment of the present invention. In FIG. 1, the distributed file system includes clients 1 corresponding to data acquisition units, a metadata server 2 corresponding to a management unit, storage nodes 3 corresponding to a plurality of storage units, and a network 9. The clients 1, the metadata server 2, and the plurality of storage nodes 3 are connected to each other via the network 9.

The clients 1 transmit a data access request. The metadata server 2 holds information about correlation between metadata and data and information about correlation between data and the storage nodes 3 storing data. The storage nodes 3 hold data.

In the present exemplary embodiment, the clients 1 use a file name when transmitting an access request, and the storage nodes 3 store data based on a unit called as an object. For example, an object signifies a file or a chunk obtained by dividing a file.

When a client 1 accesses a desired file, first, the client 1 transmits a search request. More specifically, the client 1 transmits a file name to the metadata server 2. The metadata server 2 searches for objects forming a file corresponding to the file name and transmits object identifiers and node identifiers of the storage nodes 3 storing the individual objects to the client 1. The client 1 requests the storage nodes 3 for objects, by using the node identifiers and the object identifiers obtained from the metadata server 2. After obtaining desired objects, the client 1 combines these objects to acquire the desired file.

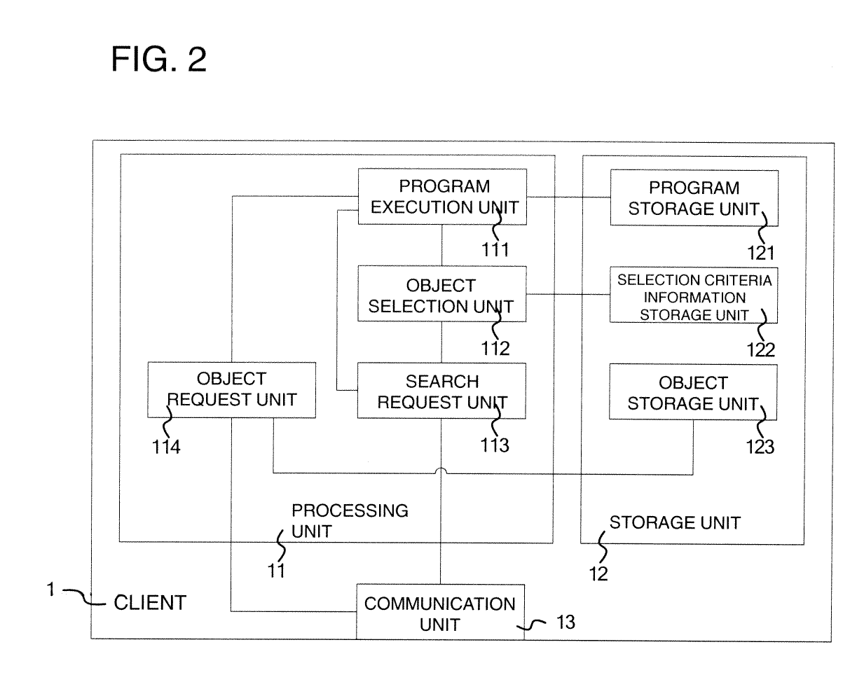

Next, a configuration of a client 1 will be described in detail with reference to FIG. 2. The client 1 includes a processing unit 11, a storage unit 12, and a communication unit 13.

For example, the processing unit 11 is realized by a computer system including a CPU (Central Processing Unit) and a memory or by dedicated electronic circuits. The processing unit 11 includes a program execution unit 111, an object selection unit 112, a search request unit 113, and an object request unit 114. Each unit of the processing unit 11 may be configured to operate by executing a predetermined program for the client.

The program execution unit 111 reads and executes a program stored in a program storage unit 121.

The object selection unit 112 determines objects to be accessed, based on a metadata search result supplied from the search request unit 113 and selection criteria information stored in a selection criteria information storage unit 122. In addition, the object selection unit 112 transmits information about the objects to be accessed to the program execution unit 111.

The search request unit 113 transmits a metadata search request to the metadata server 2 via the communication unit 13 and the network 9. In addition, the search request unit 113 receives a metadata search result from the metadata server 2 via the network 9 and the communication unit 13 and transmits the metadata search result to the object selection unit 112.

The object request unit 114 transmits an object request to a storage node 3 via the communication unit 13 and the network 9. In addition, the object request unit 114 stores the objects supplied from the storage nodes 3 via the network 9 and the communication unit 13 in an object storage unit 123.

The program execution unit 111, the object selection unit 112, the search request unit 113, and the object request unit 114 may physically be configured to operate on separate systems or two or more of the units may be configured to operate on a single system.

For example, the storage unit 12 is realized by a hard disk drive and includes the program storage unit 121, the selection criteria information storage unit 122, and the object storage unit 123.

The program storage unit 121 stores programs executed by the program execution unit 111. The selection criteria information storage unit 122 stores information about criteria used by the object selection unit 112 to select objects. The object storage unit 123 stores objects.

The communication unit 13 serves as an interface between the inside of he client 1 and the network 9.

Next, a configuration of the metadata server 2 will be described in detail with reference to FIG. 3. The metadata server 2 includes a processing unit 21, a storage unit 22, and a communication unit 23.

For example, the processing unit 21 is realized by a computer system including a CPU and a memory or by dedicated electronic circuits. The processing unit 21 includes a search unit 211, a search request processing unit 2 and an operating state management unit 213. Each unit of the processing unit 21 may be configured to operate by executing a predetermined program for the metadata server.

The search unit 211 accesses a metadata storage unit 221 to execute a metadata search based on search conditions supplied from the search request processing unit 212. In addition, the search unit 211 transmits object identifiers as a search result, to the search request processing unit 212.

The search request processing unit 212 receives a metadata search request from a client 1 via the network 9 and the communication unit 23, transmits the search conditions to the search unit 211, and receives the object identifiers as a search result from the search unit 211. In addition, the search request processing unit 212 searches the arrangement information stored in the arrangement information storage unit 222 for node identifiers corresponding to the object identifiers. Further, the search request processing unit 212 searches the operating state information stored in the operating state information storage unit 223 for operating states corresponding to the node identifiers. Further, the search request processing unit 212 transmits the object identifiers, the node identifiers, and the operating states to the client 1, from which the metadata search request is transmitted, via the communication unit 23 and the network 9.

Upon receiving an operating state change notification from a storage node 3 via the network 9 and the communication unit 23, the operating state management unit 213 updates the information stored in the operating state information storage unit 223.

The search unit 211, the search request processing unit 212, and the operating state management unit 213 may physically be configured to operate on separate systems or two or more of the units may be configured to operate on a single system.

For example, the storage unit 22 is realized by a hard disk drive and includes the metadata storage unit 221, the arrangement information storage unit 222, and the operating state information storage unit 223.

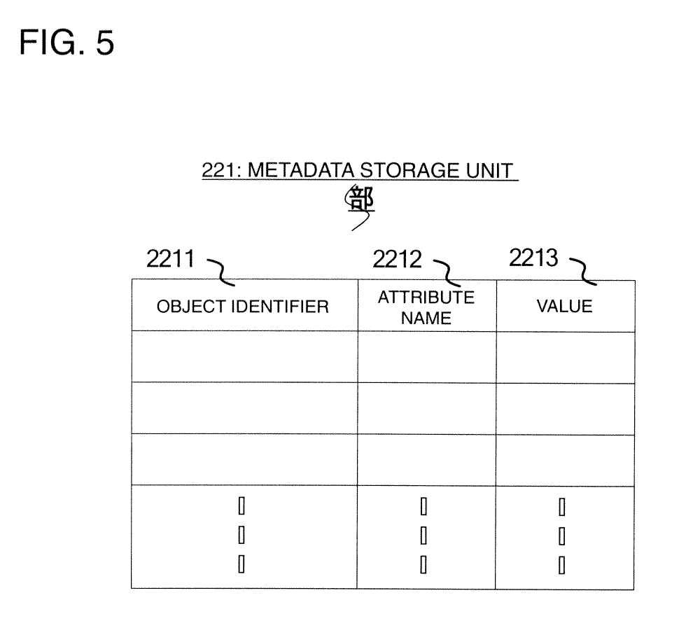

The metadata storage unit 221 stores object identifiers, metadata attribute names, and metadata values. An object identifier is uniquely given to each of the objects included in the storage nodes 3. Metadata represents information about an object and is formed by a combination of an attribute name and a value. For example, the attribute name is a creation date and the value is Aug. 22, 2000. A plurality of metadata may be given to a single object. FIG. 5 illustrates a data structure of the metadata storage unit 221. The metadata storage unit 221 has a table structure including an object identifier column 2211 storing object identifiers, an attribute name column 2212 storing attribute names, and a value column 2213 storing values. A plurality of attribute names and a plurality of values can be stored for a single object identifier. Namely, a plurality of rows having the same object identifier may be included.

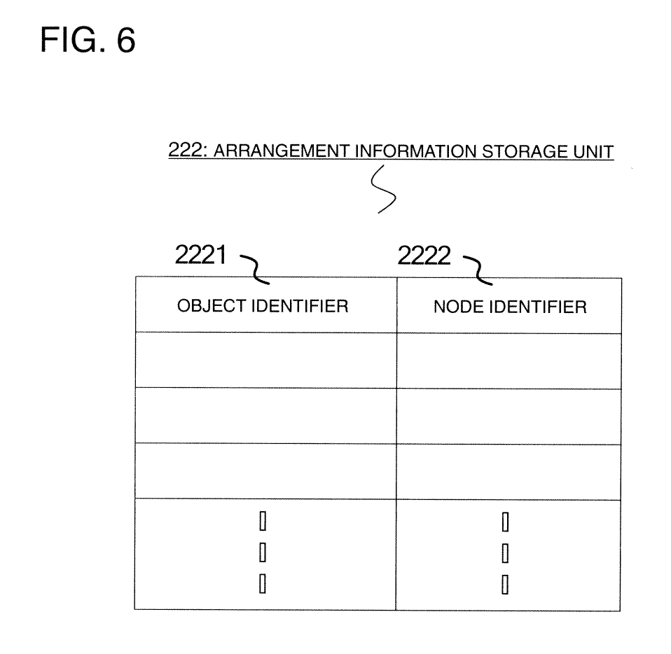

The arrangement information storage unit 222 stores object identifiers and node identifiers. A node identifier is a value for uniquely identifying a storage node 3. FIG. 6 illustrates a data structure of the arrangement information storage unit 222. The arrangement information storage unit 222 includes an object identifier column 2221 storing object identifiers and a node identifier column 2222 storing node identifiers.

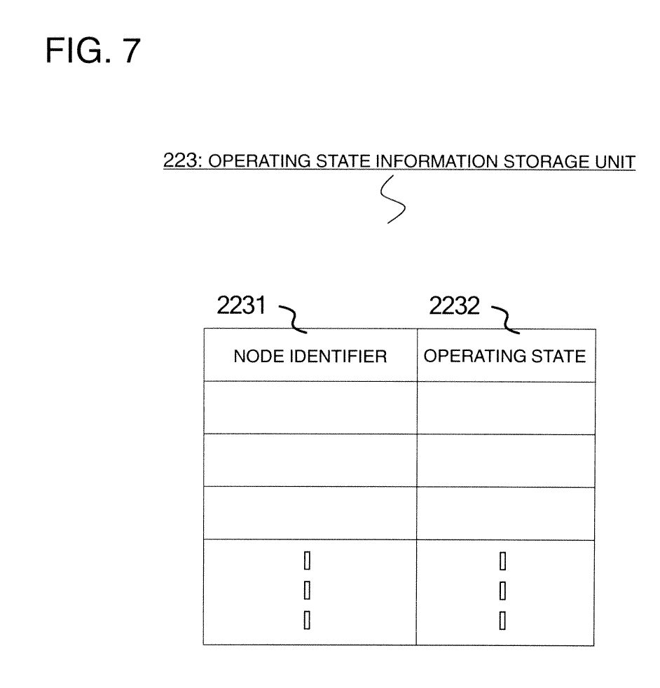

The operating state information storage unit 223 stores node identifiers and operating states. FIG. 7 illustrates a data structure of the operating state information storage unit 223. The operating state information storage unit 223 has a table structure including a node identifier column 2231 and an operating state column 2232.

The communication unit 23 serves as an interface between the interior of the metadata server 2 and the network 9.

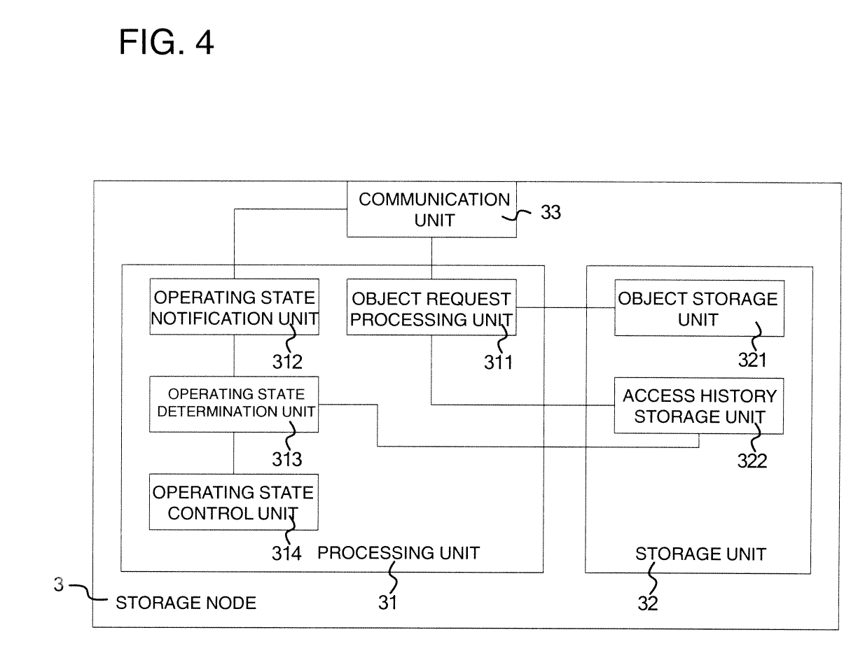

Next, a structure of a storage node 3 will be described in detail with reference to FIG. 4. The storage node 3 includes a processing unit 31, a storage unit and a communication unit 33.

For example, the processing unit 31 is realized by a computer system including a CPU and a memory or by dedicated electronic circuits. The processing unit 31 includes an object request processing unit 311, an operating state notification unit 312, an operating state determination unit 313, and an operating state control unit 314. Each unit of the processing unit 31 may be configured to operate by executing a predetermined program for the storage node.

The object request processing unit 311 reads objects from an object storage unit 321 in accordance with an object request supplied from a client 1 via the communication unit 33 and the network 9 and transmits the objects to the client 1. In addition, the object request processing unit 311 stores access histories to objects in an access history storage unit 322. For example, an access history represents an access frequency or an access date.

When the operating state of the storage node 3 is changed, the operating state notification unit 312 notifies the metadata server 2 of the node identifier and the operating state via the communication unit 33 and the network 9. Examples of the operating state include a state in which the entire single storage node 3 is activated, a state in which the entire single storage node 3 is stopped, and a state in which only a hard disk drive storing less frequently accessed objects in the object storage unit 321 is stopped. However, in the present exemplary embodiment, only the state in which the entire storage node 3 is activated and the state in which the entire storage node 3 is stopped are described. In addition, the storage node 3 can receive a request from a client 1 even in a stopped state.

The operating state determination unit 313 determines the operating state of the storage node 3, based on the access history storage unit 322. For example, when there is no access for a certain period of time, the operating state determination unit 313 determines that the operating state is in a stopped state. In addition, when in a stopped state, if the storage node 3 receives an object request from a client 1, the operating state determination unit 313 determines that the operating state needs to be changed to an active state.

The operating state control unit 314 controls the storage node 3 to be a state determined by the operating state determination unit 313.

The object request processing unit 311, the operating state notification unit 312, the operating state determination unit 313, and the operating state control unit 314 may physically be configured to operate on separate systems or two or more of the units may be configured to operate on a single system.

For example, the storage unit 32 is realized by a hard disk drive and includes the object storage unit 321 and the access history storage unit 322. The object storage unit 321 stores objects, and the access history storage unit 322 stores access histories.

The communication unit 33 serves as an interface between the interior of the storage node 3 and the network 9.

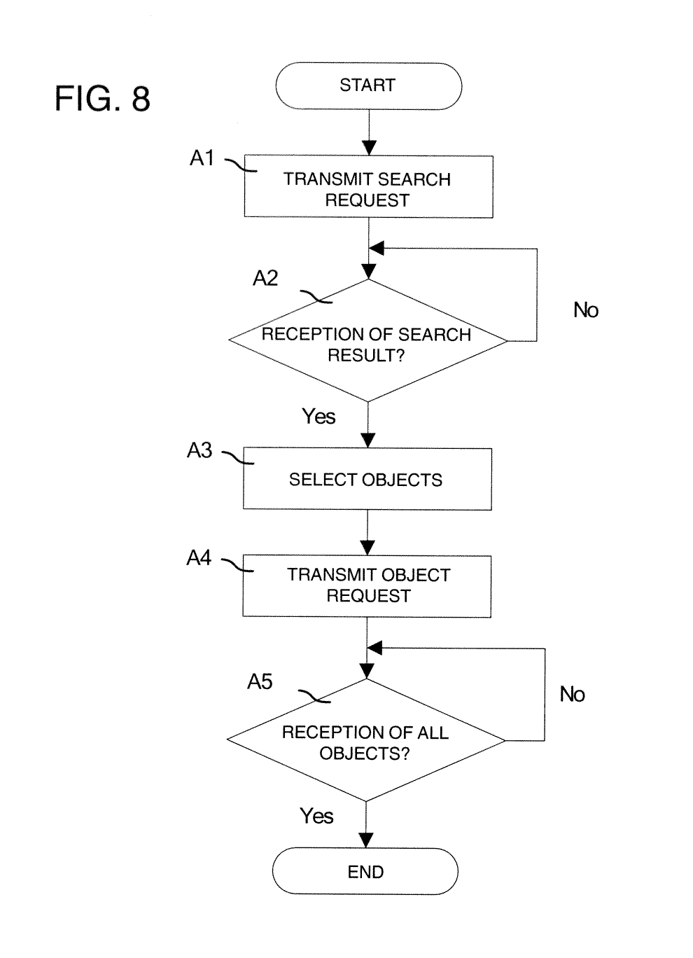

Next, an operation of a client 1 according to the present exemplary embodiment will be described with reference to a flow chart in FIG. 8.

First, a client 1 transmits a metadata search request to the metadata server 2 (step A1). When transmitting the metadata search request, the client 1 transmits a combination of a metadata attribute and a metadata value. The client 1 may transmit a plurality of combinations of attributes and values. Next, the client 1 waits to receive a search result from the metadata server 2 (step A2). After receiving a search result, the client 1 selects objects to be accessed, based on the search result and selection criteria information (step A3). Next, the client 1 transmits an object request to storage nodes 3 (step A4) and waits to receive all objects (step A5).

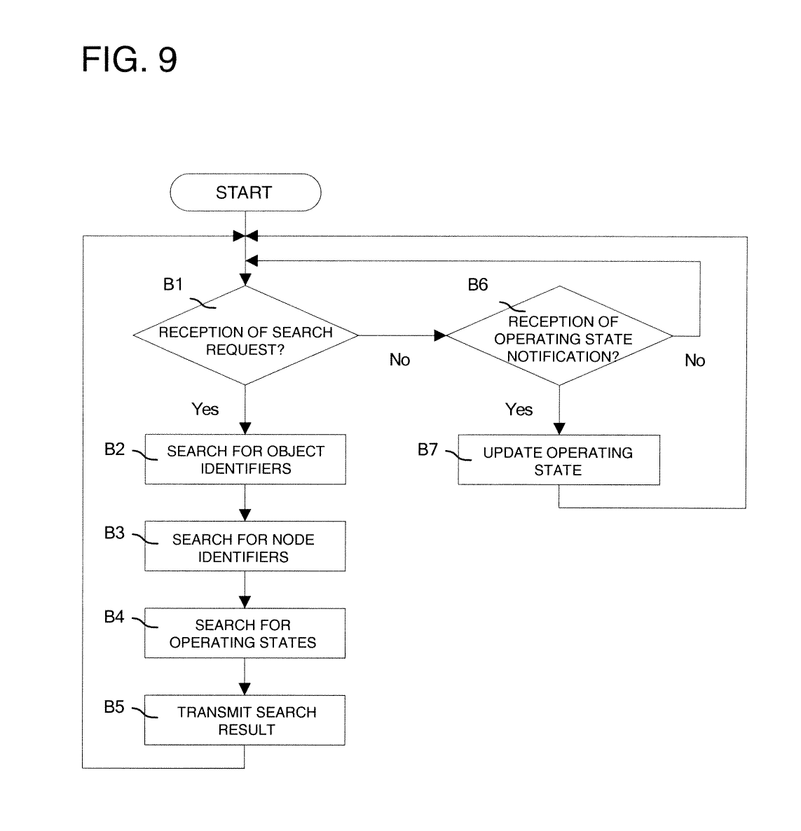

Next, an operation of the metadata server 2 according to the present exemplary embodiment will be described with reference to a flow chart in FIG. 9.

First, when receiving a metadata search request (Yes in step B1), the metadata server 2 searches for objects satisfying conditions, namely, objects having an attribute and a value in the search request, and obtains object identifiers (step B2). Next, the metadata server 2 searches for nodes including these object identifiers and obtains node identifiers (step B3). Next, the metadata server 2 searches for operating states of the nodes corresponding to the node identifiers and obtains the operating states (step B4). Next, the metadata server 2 transmits a search result to the client 1 from which the search request is transmitted (step B5). The search result represents a combination of an object identifier, a node identifier, and an operating state for each of the matching objects obtained in the metadata search. After step B5, the operation returns to step B1.

If the metadata server 2 does not receive a search request in step B1 (No in step B1), the operation proceeds to step B6. In step B6, if the metadata server 2 receives an operating state notification from a storage node 3 (step B6), the metadata server 2 updates corresponding operating state information (step B7), and the operation returns to step B1.

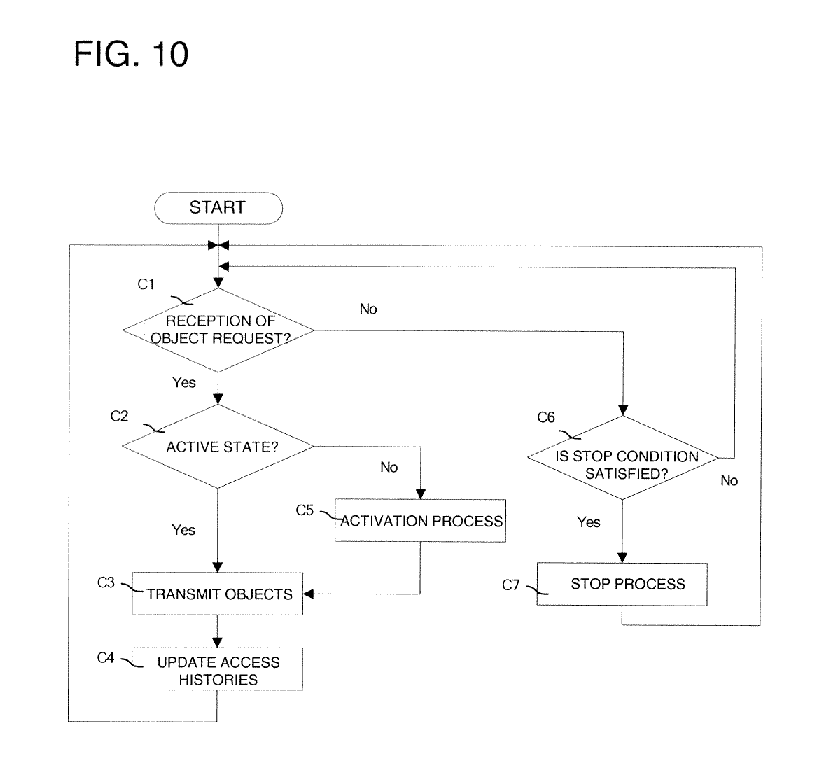

Next, an operation of a storage node 3 according to the present exemplary embodiment will be described with reference to a flow chart in FIG. 10.

First, if the storage node 3 receives an object request from a client 1 (Yes in step C1), the storage node 3 determines the operating state thereof in step C2. If in an active state (Yes in step C2), the storage node 3 transmits requested objects to the client 1 (step C3) and updates access histories (step C4). Next, the operation returns to step C1.

If in an inactive state in step C2 (No in step C2), the storage node 3 executes an activation process (step C5), and the operation proceeds to step C3.

If the storage node 3 does not receive an object request in step C1 (No in step C1), the operation proceeds to step C6. In step C6, if a stop condition is satisfied (Yes in step C6), e.g., if there is no access more than a certain period of time, the storage node 3 executes a stop process (step C7). Next, the operation returns to step C1. If the stop condition is not satisfied in step C6 (No in step C6), the operation returns to step C1.

In the above description, a simple example in which a search is executed with a file name is described. However, if the metadata server 2 manages more metadata, objects can be accessed by further advanced search based on the metadata. For example, the client 1 may transmit a search request specifying a characteristic period to the metadata server 2, and the metadata server 2 may transmit, about the files created within the given period, a list of object identifiers, node identifiers, and operating states to the client 1. In this way, the client 1 can add more conditions to narrow and select objects that are actually accessed in the list.

Next, a specific operation of the first exemplary embodiment will be described based on a simple example.

### EXAMPLE 1

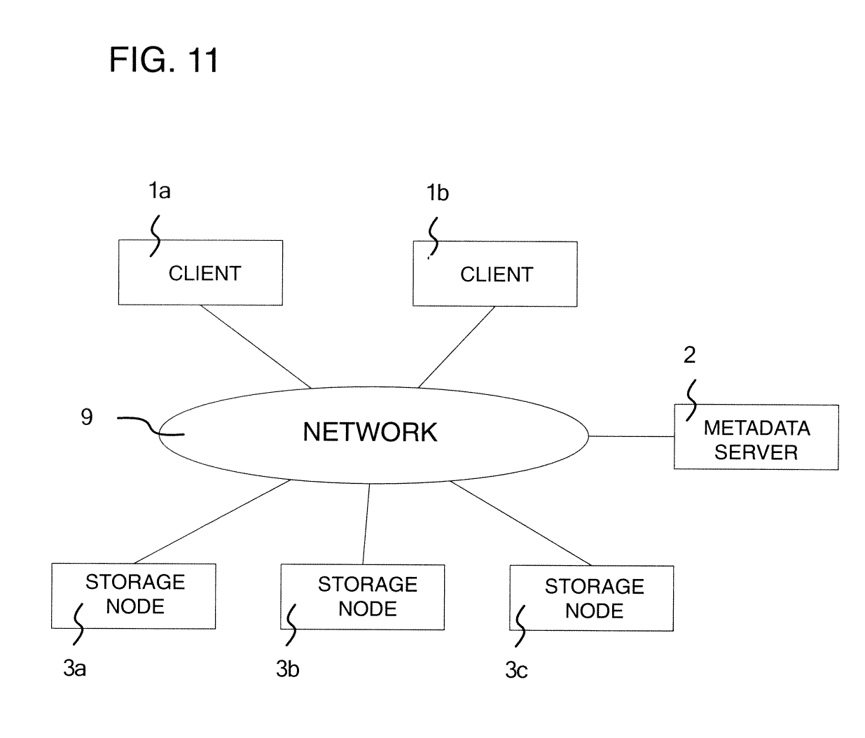

FIG. 11 illustrates a structure of a distributed file system according to a first example of the present invention. Two clients 1a and 1b are arranged as the clients 1, and three storage nodes 3a to 3c are arranged as the storage nodes 3.

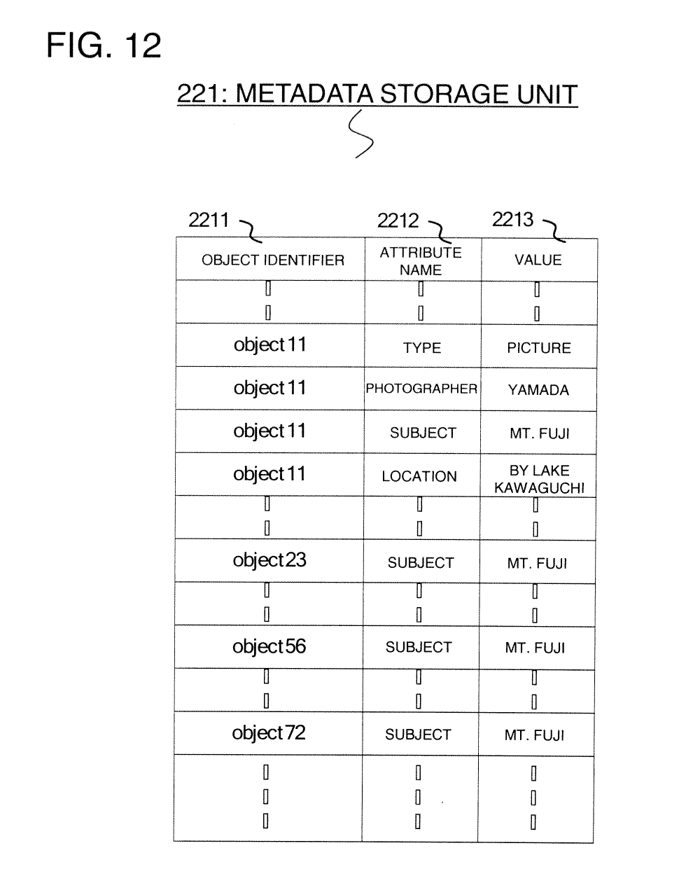

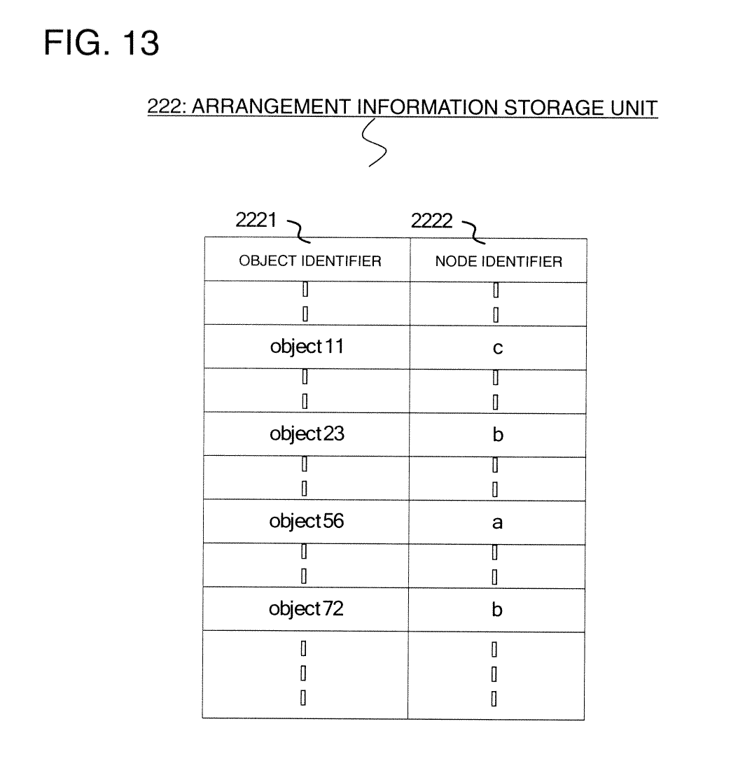

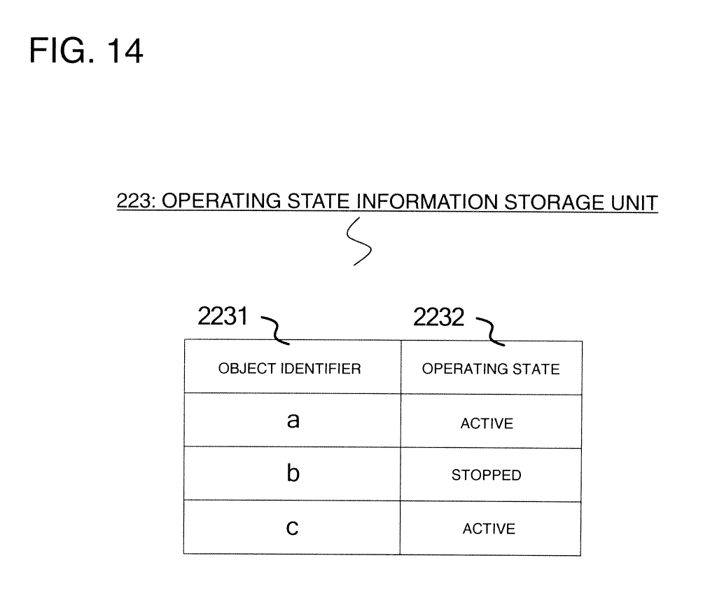

FIG. 12 illustrates part of the information in the metadata storage unit 221 in the metadata server 2 according to the present example. FIG. 13 illustrates part of the information in the arrangement information storage unit 222 in the metadata server 2 according to the present example. FIG. 14 illustrates part of the information in the operating state information storage unit 223 in the metadata server 2 according to the present example. The node identifiers a to c stored in the node identifier columns correspond to the storage nodes 3a to 3c, respectively.

In this example, the program storage unit 121 in the client 1a stores a program for acquiring pictures satisfying given metadata conditions. In addition, the selection criteria information storage unit 122 in the client 1a stores information representing “highest priority to active storage nodes and two objects.”

The present example will be described assuming that the client I a executes a program for acquiring objects corresponding to metadata “attribute name=subject, value=Mt. Fuji.”

First, the client 1a transmits a search request specifying metadata “attribute name=subject, value=Mt. Fuji” to the metadata server 2 (step A1).

When receiving the search request (Yes in step B1), the metadata server 2 searches the metadata storage unit 221 for “attribute name=subject, value=Mt. Fuji” and extracts the corresponding object identifiers (step B2). Referring to FIG. 12, in this case, four object identifiers “object11,” “object23,” “object56,” and “object72” are extracted as a search result.

Next, the metadata server 2 searches in the arrangement information storage unit 222 for node identifiers corresponding to the four object identifiers (step B3). Referring to FIG. 13, in this case, the combinations of the object identifiers and node identifiers are “object11, c,” “object23, b,” “object56, a,” and “object72, b.”

Next, the metadata server 2 searches the operating state information storage unit 223 for operating states of the storage nodes corresponding to the four node identifiers (step B4). Referring to FIG. 14, in this case, the combinations of the object identifiers, the node identifiers, and the operating states are “object11, c, active,” “object23, b, stopped,” “object56, a, active,” and “object72, b, stopped.” Next, the metadata server 2 transmits “object11, c, active,” “object23, b, stopped,” “object56, a, active,” and “object72, b, stopped” to the client 1 as a search result (step B5).

When receiving the search result (Yes in step A2), the client 1a selects objects to be accessed, in accordance with the selection criteria information “highest priority to active storage nodes” (step A3). In this case, “object11, c, active” and “object56, a, active” are selected.

Next, the client 1a requests the storage node 3c for object11 and the storage node 3a for object56 (step A4).

When the storage nodes 3c and 3a receive the respective object requests from the client 1a (Yes in step C1), since both of the storage nodes 3c and 3a are in an active state (Yes in step C2), the storage nodes 3c and 3a read object11 and object56 from the object storage units 321, respectively. Next, the storage nodes 3c and 3a transmit object11 and object56 to the client 1a (step C3) and update the access histories, respectively (step C4).

The client 1a receives object11 from the storage node 3c and object56 from the storage node 3a and stores object11 and object56 in the object storage unit 123.

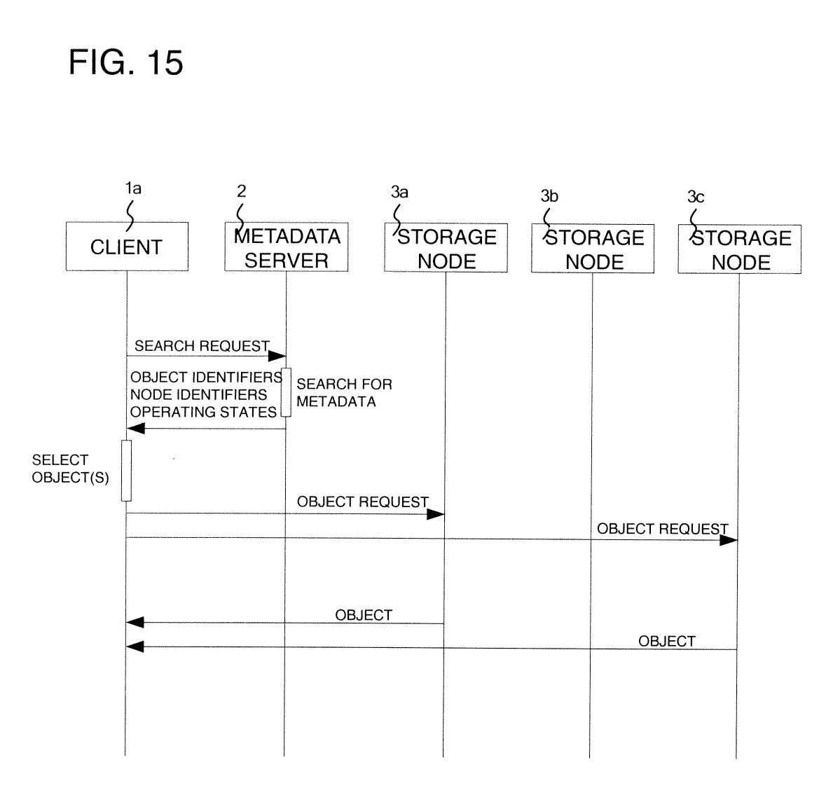

FIG. 15 is a sequence diagram illustrating the above operation.

According to the above distributed file system, the client 1a can obtain the predetermined number of objects corresponding to the predetermined metadata, without activating the storage node 3b in a stopped state. In this case, an increase of power consumption, which would be caused if the storage node 3b needed to be activated, is prevented, and the client 1a does not need to wait for the storage node 3b to be activated.

Namely, since the metadata server 2 includes the operating state information storage unit 223 and transmits the operating states of the storage nodes 3 as a result of a metadata search to the client 1 and the client 1 uses the operating states to select objects, activation of the storage servers 3 in a stopped state can be controlled. In addition, the number of increases in access time caused when the client 1 waits for the storage servers 3 to be activated can be reduced.

### SECOND EXEMPLARY EMBODIMENT

Configurations of a distributed file system, clients 1, a metadata server 2, and storage nodes 3 according to a second exemplary embodiment of the present invention are the same as those (FIGS. 1 to 4) according to the first exemplary embodiment. In addition, an operation of the storage nodes 3 according to the second exemplary embodiment is the same as that (FIG. 10) according to the first exemplary embodiment. However, the clients 1 and the metadata server 2 operate partially differently from those according to the first exemplary embodiment. In the following description, only the operations different from those according to the first exemplary embodiment will be described.

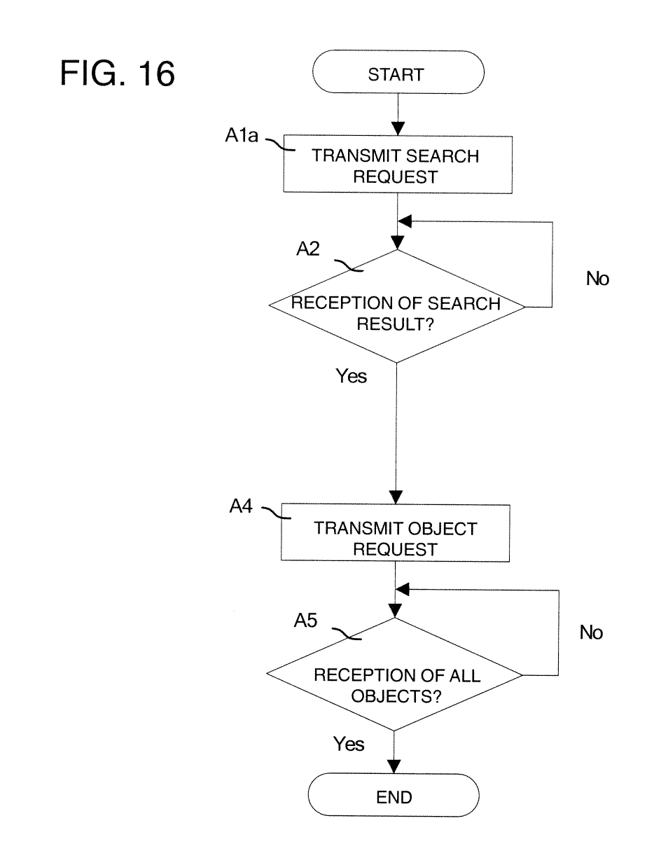

First, an operation of a client 1 according to the present exemplary embodiment will be described with reference to a flow chart in FIG. 16. The client 1 according to the second exemplary embodiment operates differently from that according to the first exemplary embodiment (step A1 in FIG. 8) in that the client 1 according to the second exemplary embodiment includes a different content in a search request when transmitting the search request (step A1a). In step A1a, when transmitting a search request, the client 1 transmits selection criteria information, in addition to a combination of a metadata attribute and a metadata value. In addition, unlike the client 1 according to the first exemplary embodiment, the client 1 according to the second exemplary embodiment does not select objects (step A3 in FIG. 8).

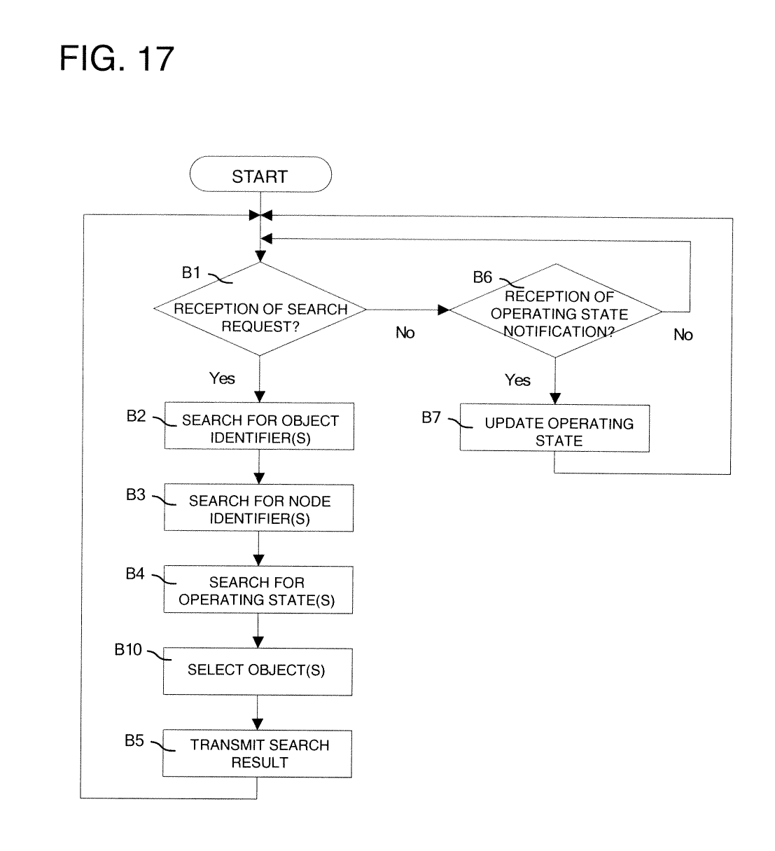

Next, an operation of the meta server 2 according to the present exemplary embodiment will be described with reference to a flow chart in FIG. 17. The meta server 2 according to the second exemplary embodiment operates differently from that according to the first exemplary embodiment (FIG. 9) in that the meta server 2 according to the second exemplary embodiment selects objects (step B10) between searching for operating states (step B4) and transmitting a search result (step B5). When selecting objects (step B10), the meta server 2 refers to the selection criteria information transmitted from the client 1.

According to the first exemplary embodiment, the client 1 selects objects. However, as described above, according to the second exemplary embodiment, the meta server 2 selects objects. In this way, compared with the first exemplary embodiment, processing load of the client 1 is reduced. Thus, the second exemplary embodiment is advantageous when the system includes low performance machines as clients 1 and a high performance machine as the meta server 2. In addition, when the meta server 2 transmits a search result to the client 1, the meta server 2 can transmit a reduced amount of data.

In the above description, the metadata server 2 includes an operating state management unit 213 and an operating state information storage unit 223. However, by arranging a separate operating state management node having these functions and allowing the operating state management node to communicate with the metadata server 2 and the storage nodes 3, the same operation may be executed.

In addition, in the above description, while the selection criteria information storage unit 122 of the client 1 includes selection criteria information, part of the selection criteria information may be determined by a program. For example, selection criteria may be inputted as program execution parameters via an external console (not illustrated), and conditions satisfying the selection criteria inputted from the outside and selection criteria included in the selection criteria information storage unit 122 may be used as the selection criteria information.

In addition, in the above description, only an active state and a stopped state are used as the operating states. However, other states relating to the power consumption may be used, such as a state in which the power is intermediate between the active state and the stopped state (for example, a state in which power supplies to some circuits are stopped). However, in this case, it is preferable that the states correspond to the power consumption levels and that the objects to be accessed be selected so that a transition from a low power consumption state to a high power consumption state is not caused as much as possible.

In addition, in the above description, the objects to be accessed are determined only by the operating state. However, another condition may be combined with the operating state. In this way, when the objects are selected, the conditions may be prioritized. For example, the objects to be accessed may be selected by acquiring the creation dates of the individual objects as metadata from the metadata server and by giving the first priority to the latest creation date and the second priority to the operating state.

In addition, in the above description, the operating state information is managed on the basis of a node. However, if the operating state is changed by a different device (a hard disk drive, for example), it is preferable that the operating state be managed on the basis of the device.

In addition, in the above description, each of the storage nodes 3 controls the operating state thereof and notifies the metadata server 2 of the operating state. However, the metadata server 2 may monitor the access histories of the storage nodes 3 and stop the storage nodes 3.

In addition, in the above description, the distributed file system is described as a client-server system via the network 9. However, the distributed file system is not limited to such example. Namely, an arbitrary system is applicable, as long as the system includes a storage system corresponding to the storage nodes, a management unit corresponding to the metadata server, and a data acquisition unit corresponding to the client.

### INDUSTRIAL APPLICABILITY

The present invention is applicable to distributed storage. In addition, the present invention is applicable to a content delivery system.

The entire disclosures of the above Patent Document are incorporated herein by reference thereto. Modifications and adjustments of the exemplary embodiments and examples are possible within the scope of the overall disclosure (including the claims) of the present invention and based on the basic technical concept of the invention. Various combinations and selections of various disclosed elements are possible within the scope of the claims of the present invention. That is, the present invention of course includes various variations and modifications that could be made by those skilled in the art according to the overall disclosure including the claims and the technical concept.

### EXPLANATIONS OF SYMBOLS

1, 1a, 1b client

11 processing unit

111 program execution unit

112 object selection unit

113 search request unit

114 object request unit

12 storage unit

121 program storage unit

122 selection criteria information storage unit

123 object storage unit

13 communication unit

2 metadata server

21 processing unit

211 search unit

212 search request processing unit

213 operating state management unit

22 storage unit

221 metadata storage unit

2211 object identifier column

2212 attribute name column

2213 value column

222 arrangement information storage unit

2221 object identifier column

2222 node identifier column

223 operating state information storage unit

2231 node identifier column

2232 operating state column

23 communication unit

3, 3a, 3b, 3c storage node

31 processing unit

311 object request processing unit

312 operating state notification unit

313 operating state determination unit

314 operating state control unit

32 storage unit

321 object storage unit

322 access history storage unit

33 communication unit

9 network

What is claimed is:

1. A distributed file system, comprising:
a storage system including a plurality of storage units that distribute and store data corresponding to metadata, each of the storage units being in one of a plurality of operating states;
a data acquisition unit that acquires data corresponding to a search request including desired metadata; and
a management unit that manages which of the storage units stores data corresponding to the metadata, manages an operating state of each of the storage units, and supplying a search result based on management contents in response to a search request from the data acquisition unit;
wherein, based on the search result, the data acquisition unit accesses the storage unit(s) in an active state more preferentially than the storage unit(s) in an inactive state to acquire desired data.

2. The distributed file system according to claim 1;
wherein the search result includes information about the storage unit(s) storing data corresponding to the desired metadata and information about operating states of the storage units; and
wherein, based on the search result, the data acquisition unit accesses the storage unit(s) to acquire the desired data.

3. The distributed file system according to claim 2;
wherein the search request further includes selection criteria information; and
wherein the search result includes information about the storage unit(s) storing data that matches the selection criteria information and that corresponds to the desired metadata and information about operating states of the storage unit(s).

4. The distributed file system according to claim 1;
wherein the storage unit in an active state has larger power consumption than the storage unit in an inactive state.

5. The distributed file system according to claim 1;
wherein the management unit includes a management storage unit that stores object identifiers corresponding to the metadata, storage unit identifiers corresponding to the object identifiers, and storage unit operating states corresponding to the storage unit identifiers; and
wherein the management unit executes a management by referring to the management storage unit.

6. The distributed file system according to claim 5;
wherein the management unit receives operating states of the storage unit(s) from the storage unit(s) and updates information in the management storage unit.

7. The distributed file system according to claim 1;
wherein the storage unit in an active state is brought in an inactive state if the storage unit satisfy a stop condition.

8. The distributed file system according to claim 1;
wherein the metadata includes a combination of an attribute and a value.

9. The distributed file system according to claim 1;
wherein the management unit and the data acquisition unit are a server and a client(s), respectively; and
wherein the storage system, the server, and the client(s) are connected via a network.

10. A data selection method used in a distributed file system comprising a storage system including: a plurality of storage units that distribute and store data corresponding to metadata, each of the storage units being in one of a plurality of operating states; a server; and
a client(s), the data selection method, comprising:
causing the client to transmit a search request including desired metadata to the server;
causing the server to transmit information about the storage unit(s) storing data corresponding to the metadata and information about operating states of the storage units to the client as a reply; and
causing the client, based on the reply from the server, to access the storage unit(s) in an active state more preferentially than the storage unit(s) in an inactive state to acquire desired data.

11. A non-transient computer readable medium storing therein a program, causing a computer, which forms a distributed file system comprising a storage system including: a plurality of storage units that distribute and store data corresponding to metadata, each of the storage units being in one of a plurality of operating states; a server; and a client(s), to execute processes of:
causing the client to transmit a search request including desired metadata to the server;
causing the server to transmit information about the storage unit(s) storing data corresponding to the metadata and information about operating states of the storage unit(s) to the client as a reply; and
causing the client, based on the reply from the server, to access the storage unit(s) in an active state more preferentially than the storage unit(s) in an inactive state to acquire desired data.

12. The distributed file system according to claim 4;
wherein the storage unit in an active state is brought in an inactive state if the storage unit satisfy a stop condition.

13. The distributed file system according to claim 2;
wherein the metadata includes a combination of an attribute and a value.

14. The distributed file system according to claim 3;
wherein the metadata includes a combination of an attribute and a value.

15. The distributed file system according to claim 5;
wherein the metadata includes a combination of an attribute and a value.
